(19) United States
(12) Patent Application Publication
(10) Pub. No.: US 2026/0233362 A1
(43) Pub. Date: Aug. 13, 2026

(54) CHAIN HANDLER FOR A CHAIN VICE

(71) Applicants: Sandy DeWaal, Leduc (CA); Dave Kutinsky, Edmonton (CA)

(72) Inventors: Sandy DeWaal, Leduc (CA); Dave Kutinsky, Edmonton (CA)

(21) Appl. No.: 19/412,797

(22) Filed: Dec. 8, 2025

Related U.S. Application Data
(60) Provisional application No. 63/729,192, filed on Dec. 6, 2024.

(51) Int. Cl. B25B 1/20; B25B 1/24

(52) U.S. Cl. CPC B25B 1/205; B25B 1/2484

(57) ABSTRACT

A chain vice has a chain handler mounted to a base. The chain handler has a first length pivotally connected to the base, and a second length pivotally connected tot eh first length. A chain guide is carried by the chain carrier and is spaced from the pivot connection. A chain has a fixed end connected to the base, and a moveable end spaced from the fixed end. The chain is supported by the chain guide that is adapted to permit the chain to move along its length through the chain guide. An actuator controls pivotal movement of the first length about the pivot mount and pivotal movement of the second length about the pivot connection between a raised position and a lowered position, the chain moving with the chain carrier to engage and disengage an object to be clamped.

### TECHNICAL FIELD

This relates to a chain handler, and in particular, a chain handler for a chain vice.

### BACKGROUND

Chain vices are used to hold round or irregularly shaped objects, such as pipes, and other. A chain vice secures an object by wrapping a chain around the object, and then tightening the chain to clamp the object in place. United States patent no. 1,054,665 (Amborn) entitled “Chain pipe-vise or the like” describes an example of a chain vice.

### SUMMARY

According to an aspect, there is provided a chain vice that has a chain handler mounted to a base. The chain handler comprises a chain carrier comprising a first length pivotally connected to a second length by a pivot connection, a pivot mount that pivotally connects the first length to the base, and a chain guide carried by the chain carrier, the chain guide being spaced from the pivot connection. A chain has a fixed end connected to the base, a moveable end spaced from the fixed end, and a length between the fixed and the moveable end. The chain is supported by the chain guide, the chain guide being adapted to permit the chain to move along its length through the chain guide. An actuator controls pivotal movement of the first length about the pivot mount and pivotal movement of the second length about the pivot connection between a raised position and a lowered position, wherein the chain moves with the chain carrier between the raised position and the lowered position, and wherein, in the lowered position, the chain carrier is adapted to permit the chain to engage an object to be clamped.

According to other aspects, the chain vice may include one or more of the following features, alone or in combination: the base may comprise an object support adapted to support the object to be clamped, the fixed end of the chain being secured on a first side of the object support, and the chain carrier extending the chain to a second side of the object support; the chain guide may be pivotally mounted to the second length of the chain carrier; the chain guide may comprise a low friction surface between side plates, the side plates limiting lateral movement of the chain; the moveable end of the chain may comprise a stop that prevents the moveable end from passing through the chain guide; the actuator may comprise a first actuator that pivots the chain carrier about the pivot mount relative to the base, and a second actuator that pivots the second length about the pivot connection relative to the first length, the second actuator being carried by the first length; the first actuator and the second actuator may be linear actuators; and the first actuator may have a fixed end that is fixedly mounted relative to the base and a moveable end that is connected to the first length.

According to an aspect, there is provided a chain handler, comprising a chain carrier, a pivot mount adapted to pivotally connect the chain carrier to a base of a chain vice, and a chain guide carried by the chain carrier, the chain guide being spaced from the pivot mount, the chain guide being adapted to support a chain while permitting the chain to move along its length through the chain guide. An actuator controls pivotal movement of the chain carrier about the pivot mount between a raised position and a lowered position.

According to another aspect, the chain handler may include one or more of the following features, alone or in combination: the chain carrier may comprise a first length pivotally connected to a second length by a pivot connection, and wherein the actuator further controls the pivotal movement of the second length relative to the first length about the pivot connection; the chain guide may be pivotally mounted to the second length; the actuator may comprise a first actuator that pivots the chain carrier about the pivot mount relative to the base, and a second actuator that pivots the second length about the pivot connection relative to the first length, the second actuator being carried by the first length; the first actuator and the second actuator may be linear actuators; the first actuator may have a fixed end that is fixedly mounted relative to the base and a moveable end that is connected to the first length; the pivot mount may be adapted to be secured to a base of a chain vice such that the chain carrier extends across an object support and such that the chain traverses the object support; the chain guide may be pivotally mounted to the chain carrier; the chain guide may comprise a low friction surface between side plates, the side plates limiting lateral movement of the chain; and the moveable end of the chain may comprise a stop that prevents the moveable end from passing through the chain guide.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a perspective view of a chain vice with a chain handler in a raised position.

FIG. 2 is a perspective view of the chain vice with the chain handler in a partially lowered position over an object.

FIG. 3 is a perspective view of the chain vice with the chain handler in a lowered position over the object.

FIG. 4 is a detailed perspective view of a first control pin.

FIG. 4 is a detailed perspective view of a second control pin with the chain handler in the raised position.

FIG. 5 is a detailed perspective view of a second control pin with the chain handler in the lowered position.

FIG. 6 is a detailed perspective view with the chain vice clamping an object.

FIG. 7 is an exploded view of the chain vice.

### DETAILED DESCRIPTION OF PREFERRED EMBODIMENTS

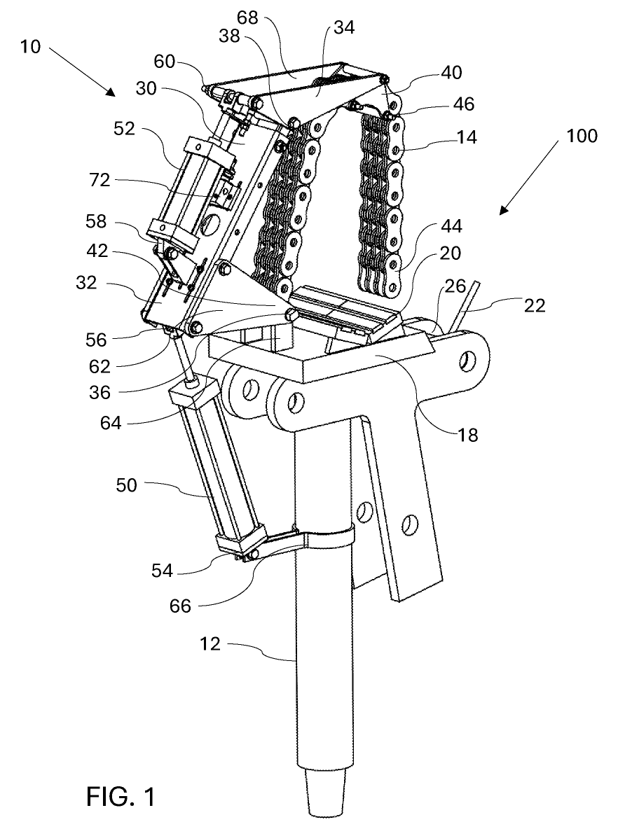

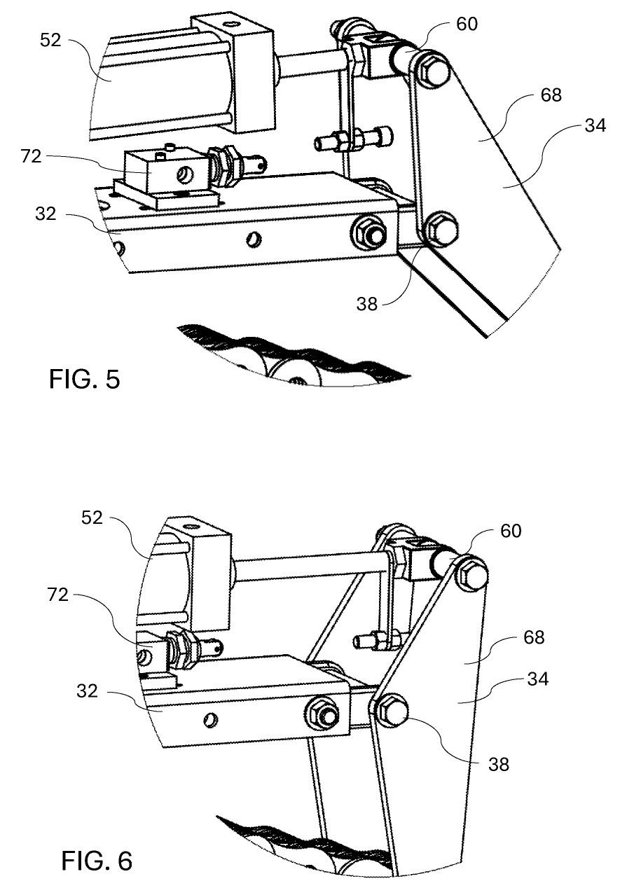

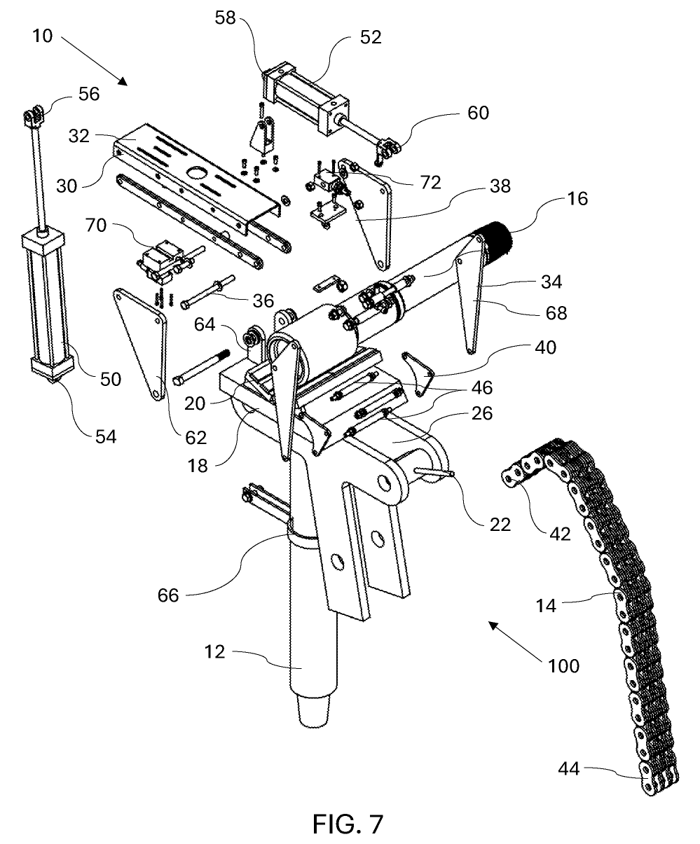

A chain handler 10 for a chain vice 100 will now be described with reference to FIG. 1 through 7.

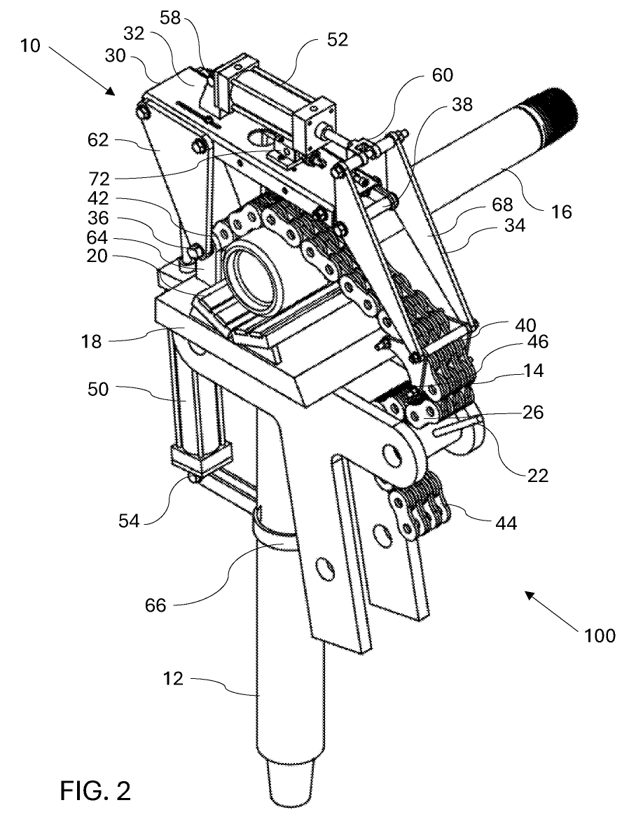

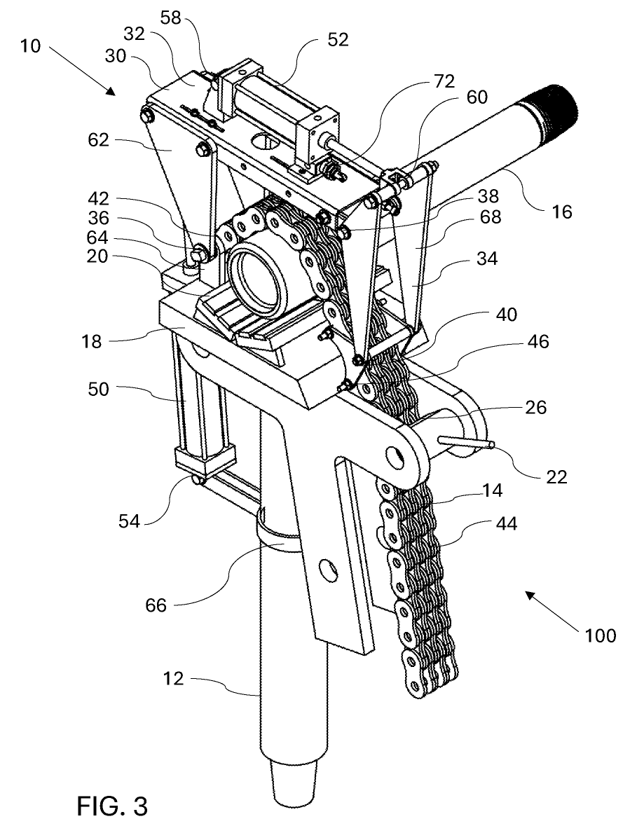

Referring to FIG. 1, chain handler 10 is intended to assist in handling a chain 14. This may be useful, for example, for large or heavy chains 14 that may be difficult to manipulate or may be a safety hazard. Chain handler 10 may also be used to suspend chain 14 while an object 16 to be clamped (shown in FIG. 2 and 3) is being positioned or manipulated before being clamped.

Referring to FIG. 2, chain vice 100 may be similar to other types of chain vices that use a chain 14 intended to be draped over and then clamped onto an object 16. By way of example, chain vice 100 may include a base 18 with a support stand 12. As shown, support stand 12 is represented by a vertical pipe that may be embedded in a shop floor, secured to a ground-engaging stand, or otherwise installed. Support stand 12 may be a permanent, semi-permanent, or portable installation. While support stand 12 is represented as a vertical pipe, it may take other forms that are sufficient to properly support chain vice 100 during use. This may vary depending on the intended use and may include considerations such as the object 16 being clamped and the type of operation being performed while clamped.

Base 18 may also support an object cradle 20 that is designed to receive and support object 16 to be clamped. Object cradle 20 may be designed as a universal support, or may be object-specific, such as to clamp a specific pipe diameter. Base 18 may have other profiles that engage object 16 and may be replaceable. A tensioning handle 22 is used to tighten chain 16 once properly positioned over object 16 in object cradle 20, as shown in FIG. 3. In the depicted example, tensioning handle 22 tightens chain 14 by pressing down on handle 22 and apply a clamping force to chain 14. There may be a chain receiver 26 that is used to help guide chain 16 as it is lowered into engagement with object 16. Chain receiver 26 may be defined by a space between handle 22 and base 18.

Referring to FIG. 1 and 2, chain handler 10 has a chain carrier 30 mounted to base 18. Chain carrier 30 has a first length 32 and a second length 34, where first length is connected to base 18 by a pivot mount 36, and second length 32 is connected to first length 32 by a pivoting connection 38 at a point spaced from pivot mount 36. Pivot mount 36 and pivoting connection 38 may include pin connectors as shown or may be another suitable type of hinge. Pivot mount 36 allows chain carrier 30 to move relative to base 18, and second length 34 carries a chain guide 40 that is spaced from pivoting connection 38. Chain 14 is positioned below chain carrier 30 such that chain carrier 30 does not interfere with chain 14 as it is raised and lowered into engagement with object 16 being clamped. Chain 14 has a fixed end 42 on one side of cradle 20, and a free end 44 on the opposite side of cradle 20. As shown, fixed end 42 shares the same connection point as pivot mount 36, although it could also be connected at a different point. Fixed end 42 may not be permanently connected to base 18, instead, fixed end 42 has a fixed position during a clamping event relative to moveable end 44. In this manner, during a clamping event, chain 14 has two points of contact on either side of object 16. The clamping force is made up using chain carrier 30 to lift and suspend chain 14 over object 16, then lower chain 14 until chain 14 overlies object 16 such that actuating handle 22 causes chain 14 to apply a clamping force to object 16 to secure it in place. In this manner, the chain carrier is able to lift and lower chain 14 relative to cradle 20 as chain guide 40 is lifted and lowered. Chain guide 40 may be designed to allow chain 14 to slide therethrough as the distance between fixed end 42 and chain guide 40 varies, while preventing chain 14 from moving laterally as it is lowered and lifted relative to cradle 20. This allows slack in chain 14 to be removed when in the raised position and allows chain 14 to conform to object 16 being clamped as it is lowered without applying a clamping force before handle 22 is actuated. Chain 14 may be long enough that the weight of chain 14 hanging from chain guide 40 is sufficient to keep tension on chain 14 between fixed end 42 and chain guide 40. Moveable end 44 of chain 14 may also be fitted with a stop (not shown) that is large enough to prevent moveable end 44 from passing through chain guide 40 and allow chain 14 from falling out of chain guide 40. Chain guide 40 may have a low friction surface that facilitates movement of chain 14 through chain guide 40, such as one or more rollers 46. Chain guide 40 may also be pivotally mounted to second length 34 of chain carrier 30. As described, chain handler 10 is designed to help raise and lower chain 14 relative to object cradle 20, with chain 14 clamped and released by chain vice 100 using components, such as levers, screw clamps, etc. as is known in the art, which may vary from what is depicted.

The movement of chain carrier 30 is controlled by an actuator that, as shown, includes a first actuator 50 and a second actuator 52. Actuators 50 and 52 may be hydraulic or pneumatic cylinders as depicted. Other types of actuator(s) may also be used, such as rotary actuators, etc. First actuator 50 controls the pivotal movement of first length 32 about pivot mount 36 relative to base 18, and second actuator 52 controls the pivotal movement of second length 34 about pivoting connection 38 relative to first length 32. As shown, first actuator 50 has a fixed end 54 and a moveable end 56, and second actuator has a fixed end 58 and a moveable end 60. First actuator 50 is mounted between base 18 and first length 32. First actuator 50 connects with first length 32 at a point that is spaced from the pivot axis of pivot mount 36 to allow for some leverage. As shown, pivot mount 36 is made up of triangular plates 62, the apex of which is mounted to flanges 64 on base 18. Fixed end 54 of first actuator 50 is fixed relative to the base of triangular plates 62 such that chain carrier 30 pivot about the apex of triangular plates 62 as moveable end 60 extends and retracts. As shown, fixed end 54 of first actuator 50 is secured to support stand 12 by a clamp 66. It will be understood that triangular plates 62 may be replaced with other shapes or styles of supporting components that also permit for the necessary leverage to be achieved in order to cause chain carrier 30 to move and to allow for the required pivotal movement for a given application and provide suitable support the expected loads. For example, plates 62 may be replaced with one or more rods or rectangular plates that allow for a suitable pivot connection to be made. In other examples, there may be a single component rather than a pair of plates, the plates may be spaced more toward the middle of the first length relative to the end, or any suitable position. Other design considerations may apply where first actuator 50 is a different type of actuator other than a linear actuator.

Fixed end of 58 of second actuator 52 is mounted to first length 32 moveable end 60 connects to second length 34 at a point that is spaced from the pivot axis of pivoting connection 38. As shown, second length 34 is also made up of a pair of triangular plates 68, where the first vertex is pivotally connected to first length 32, a second vertex is connected to moveable end 60 of second actuator 52, and a third vertex is connected to chain guide 40. In this example, as moveable end 60 extends and retracts, triangular plates 68 pivot relative to first length 32 and move chain guide 40. Chain guide 40 may be pivotally mounted to triangular plates 68 to maintain an optimal orientation relative to clamping chain 14 that is being carried. The overall position of second length 34 may also be controlled by the movement of first actuator 50 and first length 32. Similar to the considerations with respect to triangular plates 62 and first length 32, the design of second length 34 and triangular plates 68 may vary and may be any suitable design that allows for the required pivotal movement for a given application, and other design considerations may apply where second actuator 52 is a different type of actuator other than a linear actuator.

As shown, chain carrier 30 is mounted to chain vice 100 on one side of object cradle 20 and extends in a cantilevered fashion to form an enclosure or cover over object cradle 20. Clamping chain 14 is supported within this enclosure, i.e., below chain carrier 30. First and second actuators 50 and 52 may be positioned outside this enclosure to increase the size of the enclosure, and to reduce the risk of interference with chain 14 below chain carrier 30.

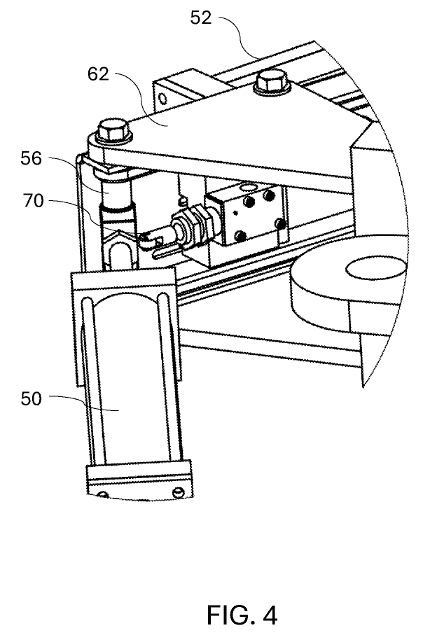

Referring to FIGS. 4, 5, and 6, first and second actuators 50 and 52 may be controlled by switches (not shown) that cause actuators 50 and 52 to extend and retract. As shown, limit switches 70 and 72 are included to stop the movement of actuators 50 and 52 when the limit is reached. Other control mechanisms may also be used, including a remote or wireless controller that allows clamping chain 14 to be raised and lowered with a worker at a safe distance from chain vice 100.

In some examples, chain handler 10 may be manufactured as part of chain vice 100, or may be designed to be retrofit onto an existing chain vice. If designed to be installed on an existing chain vice, the various components depicted and/or discussed above may be adapted with attachments, such as bands, clamps, anchors, weld points, etc. that allow it to be securely fastened to the base of chain vice 100.

In other examples, chain carrier 30 may be controlled by a single actuator that moves chain carrier 30 such that chain 14 is moved into and out of engagement with object 16. Where chain carrier 30 has a pivoting connection 38, the single actuator may control the movement about both pivoting connection 38 and pivot mount 36, which may occur in series. Chain carrier 30 may also be designed without pivoting connection 38. In this example, chain carrier 30 may be U-shaped or L-shaped to ensure chain 14 is properly positioned in the lowered position. By providing chain carrier 30 with first and second lengths 32 and 34 connected by pivoting connection 38, a greater work area under chain carrier 30 is available when lifted.

During use, FIG. 1 shows chain vice 100 with actuators 50 and 52 retracted such that chain carrier 30 and chain 14 are in a raised position. Referring to FIG. 2, object 16 has been placed on cradle 20, and first actuator 50 has been extended such that first length 32 pivots about pivot mount 36 toward object 16, and such that chain 14 is lowered into contact with object 16. As first length 32 pivots, chain 14 is permitted to slide through chain guide 40. The weight of chain 14 may be sufficient to avoid excess between fixed end 42 of chain 14 and chain guide 40 chain carrier 30 moves. As chain 14 is lowered, it may be inserted into and lowered through chain receiver 26. Referring to FIG. 3, second actuator 52 is extended such that second length 34 pivots about pivoting connection 38 and moves toward cradle 20 and object 16 until chain 14 is placed into close contact with object 16. Handle 22 is then actuated to clamp chain 14 against object 16. Object 16 is released by reversing these steps. Referring to FIGS. 4, 5, and 6,as actuators 50 and 52 are retracted, limit switches 70 and 72 limit the movement into the retracted position.

In this patent document, the word "comprising" is used in its non-limiting sense to mean that items following the word are included, but items not specifically mentioned are not excluded. A reference to an element by the indefinite article "a" does not exclude the possibility that more than one of the elements is present, unless the context clearly requires that there be one and only one of the elements.

The scope of the following claims should not be limited by the preferred embodiments set forth in the examples above and in the drawings, but should be given the broadest interpretation consistent with the description as a whole.

What is claimed is:

1. A chain vice, comprising:
a chain handler mounted to a base, the chain handler comprising:
a chain carrier comprising a first length pivotally connected to a second length by a pivot connection;
a pivot mount that pivotally connects the first length to the base; and
a chain guide carried by the chain carrier, the chain guide being spaced from the pivot connection;
a chain having a fixed end connected to the base, a moveable end spaced from the fixed end, and a length between the fixed and the moveable end, the chain being supported by the chain guide, the chain guide being adapted to permit the chain to move along its length through the chain guide; and
an actuator that controls pivotal movement of the first length about the pivot mount and pivotal movement of the second length about the pivot connection between a raised position and a lowered position, wherein the chain moves with the chain carrier between the raised position and the lowered position, and wherein, in the lowered position, the chain carrier is adapted to permit the chain to engage an object to be clamped.

2. The chain vice of claim 1, wherein the base comprises an object support adapted to support the object to be clamped, the fixed end of the chain being secured on a first side of the object support, and the chain carrier extending the chain to a second side of the object support.

3. The chain vice of claim 1, wherein the chain guide is pivotally mounted to the second length of the chain carrier.

4. The chain vice of claim 1, wherein the chain guide comprises a low friction surface between side plates, the side plates limiting lateral movement of the chain.

5. The chain vice of claim 4, wherein the moveable end of the chain comprises a stop that prevents the moveable end from passing through the chain guide.

6. The chain vice of claim 1, wherein the actuator comprises a first actuator that pivots the chain carrier about the pivot mount relative to the base, and a second actuator that pivots the second length about the pivot connection relative to the first length, the second actuator being carried by the first length.

7. The chain vice of claim 6, wherein the first actuator and the second actuator are linear actuators.

8. The chain vice of claim 7, wherein the first actuator has a fixed end that is fixedly mounted relative to the base and a moveable end that is connected to the first length.

9. A chain handler, comprising:
a chain carrier;
a pivot mount adapted to pivotally connect the chain carrier to a base of a chain vice;
a chain guide carried by the chain carrier, the chain guide being spaced from the pivot mount, the chain guide being adapted to support a chain while permitting the chain to move along its length through the chain guide; and
an actuator that controls pivotal movement of the chain carrier about the pivot mount between a raised position and a lowered position.

10. The chain handler of claim 9, wherein the chain carrier comprises a first length pivotally connected to a second length by a pivot connection, and wherein the actuator further controls the pivotal movement of the second length relative to the first length about the pivot connection.

11. The chain handler of claim 10, wherein the chain guide is pivotally mounted to the second length.

12. The chain handler of claim 10, wherein the actuator comprises a first actuator that pivots the chain carrier about the pivot mount relative to the base, and a second actuator that pivots the second length about the pivot connection relative to the first length, the second actuator being carried by the first length.

13. The chain vice of claim 12, wherein the first actuator and the second actuator are linear actuators.

14. The chain vice of claim 13, wherein the first actuator has a fixed end that is fixedly mounted relative to the base and a moveable end that is connected to the first length.

15. The chain handler of claim 9, wherein the pivot mount is adapted to be secured to a base of a chain vice such that the chain carrier extends across an object support and such that the chain traverses the object support.

16. The chain handler of claim 9, wherein the chain guide is pivotally mounted to the chain carrier.

17. The chain handler of claim 9, wherein the chain guide comprises a low friction surface between side plates, the side plates limiting lateral movement of the chain.
